(19) United States
(12) Patent Application Publication
(10) Pub. No.: US 2008/0107992 A1
(43) Pub. Date: May 8, 2008

(54) IMAGE FORMING METHOD, IMAGE FORMING APPARATUS, AND DEVELOPER

(75) Inventor: Shoko Shimmura, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/936,207

(22) Filed: Nov. 7, 2007

Related U.S. Application Data
(60) Provisional application No. 60/864,699, filed on Nov. 7, 2006.

(30) Foreign Application Priority Data
Sep. 28, 2007 (JP) 2007-255882

(51) Int. Cl. G03G 13/16; G03G 9/08

(52) U.S. Cl. 430/110.4; 430/105; 430/125.5

(57) ABSTRACT

An image forming method of forming an image by transferring a toner image, which is formed on an image bearing member by toner particles, to a transfer medium is provided. The toner particles include a coloring agent and a resin. When an average electrostatic adhesive force Fe of the toner particles to the image bearing member is expressed by the following expression, a/r satisfies 0.2≦a/r≦0.7:

$${F}_{e} = \frac{{ɛ}^{′} - 1}{{ɛ}^{′} + 1} \cdot \frac{{q}^{2} {r}^{2}}{4 {{πɛ}_{0} ( {r}^{2} - {a}^{2} )}^{2}}$$

where ε′ is a specific dielectric constant of the image bearing member, q is an electrification quantity per one toner particle, and r is a volume average radius of the toner particles.

### CROSS-REFERENCE TO RELATED APPLICATIONS

This application is based upon and claims the benefit of priority from the prior provisional application No. 60/864,699, filed on Nov. 7, 2006, and the prior Japanese Patent Application No. 2007-255882, filed on Sep. 28, 2007, the entire contents of which are incorporated herein by reference.

### BACKGROUND OF THE INVENTION

1. Field of the Invention

The present invention relates to an image forming method, and a developer, which are used to form an image in an electrophotographic manner like a copier, a printer, and the like.

2. Description of the Related Art

Generally, in image forming apparatuses using an electrophotographic manner, a toner is transferred through intermediate transfer medium like an electrostatic latent image bearing member such as a photoconductive member and a transport medium such as a transfer belt is attached to desired positions on a transfer medium such as a sheet of paper. An image is formed on the transfer medium by pressing the toner with a heating roller or the like to fix the toner onto the transfer medium.

At this time, the toner is attached to the transport medium by means of an electrostatic force based on the charge quantity of the toner particles, a Van der Walls force, and a liquid bridge forming force. The attached toner is detached from the medium mainly by means of an external electric field and is attached again to a next transport medium. The toner attached to and detached from the transport medium and transported is finally fixed to a transfer medium. Accordingly, by electrostatically controlling an adhesive force of the toner to the medium, the toner can be efficiently transported to finally form an image with high quality. That is, it is possible to improve a transfer characteristic.

In recent years, a cleaner-less process was applied to an image forming apparatus. In the cleaner-less process, the toner on the photoconductive member can be collected at the same time as development by electrostatically controlling the adhesive force without using any cleaner. However, the cleaner-less process has a problem in that exposure is hindered by an affection of the transfer residual toner or the collection time to the developing device is not appropriate and thus re-transferred, resulting from the control failure of the adhesive force, thereby causing an image defect.

When such a cleaner-less process is applied to a tandem color image forming apparatus, the toner transferred from the photoconductive member to a (intermediate) transfer medium may be pressed by means of a transfer electric field in a transfer area from the photoconductive member at the later stage and thus may be inversely transferred. When the inversely transferred toner is collected to the developing device in the cleaner-less process, color toners at the previous stage are mixed, thereby making it difficult to control colors. In general, when the transfer electric field is enhanced to improve transfer efficiency, the inverse transfer may more easily occur. Accordingly, there is a problem that a condition for preventing the inverse transfer should be employed at the cost of some degree of transfer efficiency.

In order to detach and transport the toner from the transport medium by means of an external electric field, it is necessary to multiply an electric field (necessary transfer electric field), which enhances the toner electrification quantity x the electric field strength, by the adhesive force of the toner to the transport medium. Accordingly, the necessary transfer electric field E varies with a variation in toner electrification quantity with the lapse of time or with a variation depending on the environment. In recent years, the particle diameter of the toner is reduced to improve the image quality. Since the surface area increases with the decrease in particle diameter, the electrification quantity per weight Q/M greatly varies even with a slight variation in surface charge density. Therefore, even when the toner electrification quantity varies to some extent, it is desirable that the necessary transfer electric field should be stably controlled without any great variation.

Various methods of improving a transfer characteristic mainly by the use of the adhesive force have been suggested. For example, Japanese Unexamined Patent Application Publication No. 2004-212540 discloses a method of reducing the adhesive force of a non-electrified toner to an image bearing member to reduce the amount of transfer residual toner by defining the adhesive force F of the non-electrified toner to the image bearing member/the volume average diameter D to be smaller than or equal to 4.5 nN/μm to weaken the adhesive force of the non-electrified toner. However, the electrostatic control of the adhesive force and the affection of a variation in toner electrification quantity are not described at all.

### SUMMARY OF THE INVENTION

An advantage of the invention is that it provides an image forming method, and a developer, which can suppress a variation in appropriate transfer bias electric field, and provide a stable transfer characteristic with high efficiency and an image with high quality even when the toner electrification quantity varies with the lapse of time or depending on the environment.

According to an aspect of the invention, there is provided an image forming method of forming an image by transferring a toner image, which is formed on an image bearing member by toner particles, to a transfer medium, wherein the toner particles include a coloring agent and a resin, and wherein when an average electrostatic adhesive force Fe of the toner particles to the image bearing member is expressed by the following expression, a/r satisfies 0.2≦a/r≦0.7:

$${F}_{e} = \frac{{ɛ}^{′} - 1}{{ɛ}^{′} + 1} \cdot \frac{{q}^{2} {r}^{2}}{4 {{πɛ}_{0} ( {r}^{2} - {a}^{2} )}^{2}}$$

where ε′ is a specific dielectric constant of the image bearing member, q is an electrification quantity per one toner particle, and r is a volume average radius of the toner particles.

According to another aspect of the invention, there is provided an image forming method of forming an image by transferring a toner image, which is formed on an image bearing member by toner particles, to a transfer medium via a transport medium, wherein the toner particles include a coloring agent and a resin, and wherein when an average electrostatic adhesive force Fₑ of the toner particles to the transport medium is expressed by the following expression, a/r satisfies 0.2≦a/r≦0.7:

$${F}_{e} = \frac{{ɛ}^{′} - 1}{{ɛ}^{′} + 1} \cdot \frac{{q}^{2} {r}^{2}}{4 {{πɛ}_{0} ( {r}^{2} - {a}^{2} )}^{2}}$$

where ε′ is a specific dielectric constant of the transport medium, q is an electrification quantity per one toner particle, and r is a volume average radius of the toner particles.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the forging general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate an embodiment of the invention and together with the description, serve to explain the principles of the invention.

FIG. 1 is a perspective view illustrating a sample set used to measure an average of adhesive force particles according to an embodiment of the invention;

FIG. 2 is a cross-sectional view illustrating a cell used to measure the average of adhesive force particles according to the embodiment of the invention;

FIG. 3A is a perspective view illustrating an angle rotor used to measure the average of adhesive force particles according to the embodiment of the invention;

FIG. 3B is a cross-sectional view illustrating an angle rotor used to measure the average of adhesive force particles according to an embodiment of the invention;

FIG. 4 is a conceptual diagram illustrating an image forming apparatus using a 2-component developing process according to the embodiment of the invention;

FIG. 5 is a conceptual diagram illustrating an image forming apparatus using a cleaner-less process according to an embodiment of the invention;

FIG. 6 is a conceptual diagram illustrating an image forming apparatus using a 4-drum tandem process according to an embodiment of the invention;

FIG. 7 is a conceptual diagram illustrating an image forming apparatus using a 4-drum tandem process with an intermediate transfer medium disposed therein according to an embodiment of the invention;

FIG. 8 is a diagram illustrating a relation between an electrification quantity of toner particles and a necessary transfer electric field according to an embodiment of the invention;

FIG. 9 is a diagram illustrating a relation between an electrification quantity of toner particles and a necessary transfer electric field according to an embodiment of the invention;

FIG. 10 is a diagram illustrating a relation between an electrification quantity of toner particles and a necessary transfer electric field according to an embodiment of the invention;

FIG. 11 is a diagram illustrating a relation between an electrification quantity of toner particles and a necessary transfer electric field according to an embodiment of the invention.

### DETAILED DESCRIPTION OF THE EMBODIMENTS

Reference will now be made in detail to exemplary embodiments of the invention, an example of which is illustrated in the accompanying drawings. Wherever possible, the same reference numerals will be used throughout the drawings to refer to the same or like parts.

According to an embodiment of the invention, there is provided an image forming method of forming an image by transferring a toner image, which is formed on an image bearing member by toner particles, to a transfer medium. The toner particles include a coloring agent and a resin. In addition, when an average electrostatic adhesive force Fₑ of the toner particles to the image bearing member is expressed by the following expression, a/r satisfies 0.2≦a/r≦0.7:

$${F}_{e} = \frac{{ɛ}^{′} - 1}{{ɛ}^{′} + 1} \cdot \frac{{q}^{2} {r}^{2}}{4 {{πɛ}_{0} ( {r}^{2} - {a}^{2} )}^{2}} \qquad ( 1 )$$

where ε′ is a specific dielectric constant of the image bearing member, q is an electrification quantity per one toner particle, and r is a volume average radius of the toner particles.

According to another embodiment of the invention, there is provided an image forming method of forming an image by transferring a toner image, which is formed on an image bearing member by toner particles, to a transfer medium via a transport medium. The toner particles include a coloring agent and a resin. In addition, when an average electrostatic adhesive force Fₑ of the toner particles to the transport medium is expressed by the following expression, a/r satisfies 0.2≦a/r≦0.7:

$${F}_{e} = \frac{{ɛ}^{′} - 1}{{ɛ}^{′} + 1} \cdot \frac{{q}^{2} {r}^{2}}{4 {{πɛ}_{0} ( {r}^{2} - {a}^{2} )}^{2}} \qquad ( 1 )$$

where ε′ is a specific dielectric constant of the transport medium, q is an electrification quantity per one toner particle, and r is a volume average radius of the toner particles.

Here, the toner particles include coloring agents of known pigments and dyes such as carbon black, condensed polycyclic pigments, azo-based pigments, phthalocyanine-based pigments, and inorganic pigments and a binder resin such as a polyester resin, a styrene-acrylic resin, and a cyclic olefin-based resin. The toner particles are manufactured by a crushing method or a chemical method such as a polymerization process, with a publicly known composition to which auxiliary fixing agents such as polyethylene-based wax, polypropylene-based wax, carnauba wax, rice wax, and paraffin wax, charge controlling agents (CCA), inorganic particulates for the purpose of improvement in fluidity such as silica, alumina, and titanium oxide, and organic particulates are externally added.

Known photoconductive member such as organic photoconductor (OPC) electrified in plus or minus and amorphous silicon is used for the image bearing member (electrostatic latent image bearing member) In the photoconductive member, a charge generating layer, a charge transport layer, and a protective layer may be stacked or a layer having a plural-layer function of these layers may be formed. The transport medium is one of a transfer belt, an intermediate transfer belt, and a roller. The transfer medium is a medium such as a sheet of paper on which an image is finally formed.

The toner particles are used as a 1-component developer. The toner particles may be used as a 2-component developer by adding magnetic carriers thereto. The magnetic carriers include magnetic particles such as ferrite, magnetite, oxidized steel, or resin particles into which the magnetic powder is mixed, or particles in which at least a part of the surfaces of the magnetic powder is coated with fluorine resins, silicone resins, or acrylic resins.

A volume average diameter of magnetic carrier particles is preferably in the range of 20 to 100 μm. When the volume average diameter is smaller than 20 μm, the magnetic force of one particle is small and the toner particles can be easily separated from a developer bearing member and attached to the photoconductive member. When the volume average diameter is greater than 100 μm, a magnetic brush is hardened and thus brush marks are formed in an image or a dense toner supply is not possible the volume average diameter is more preferably in the range of 30 to 60 μm.

An average value Fₑ of an electrostatic adhesive force of the toner particles to the transport medium is calculated from an average adhesive force F (N) of the toner particles to the transport medium and a non-electrostatic adhesive force F₀ of the toner particles.

The average adhesive force F (N) of the toner particles to the transport medium is measured as follows, by the use of a preparative ultracentrifuge (CP100MX) made by Hitachi Koki, an angle rotor (P100AT2), and a cell manufactured to measure a powder adhesive force.

### Method of Measuring Average Adhesive Force F (N)

(1) A sheet having on the surface thereof a surface protecting layer equivalent to that of the transport medium of which the adhesive force should be measured is prepared. For example, a sheet equivalent to a photoconductive sheet is prepared when it is intended to measure the adhesive force to the photoconductive member and a sheet equivalent to a belt material is prepared when it is intended to measure the adhesive force to the intermediate transfer belt.

It is preferable that the surface protecting layer is equivalent so as to measure the adhesive force. Similarly to an actual one, a charge generating layer (CGL) and a charge transport layer (CTL) may be stacked thereon. Since the adhesive force has greater dependency on a shape (surface roughness), an electrification quantity of the toner particles, environmental temperature and humidity, and the like than the material to be attached, they need not be strictly the same.

This sheet is wound on an aluminum element tube with the photoconductive layer set to the GND potential, and is set at a position of a photoconductive drum. Similarly to forming a usual image, the toner is developed and attached to the surface. In measuring the adhesive force of the toner to the intermediate transfer belt, the toner is transferred to the sheet equivalent to the intermediate transfer belt material.

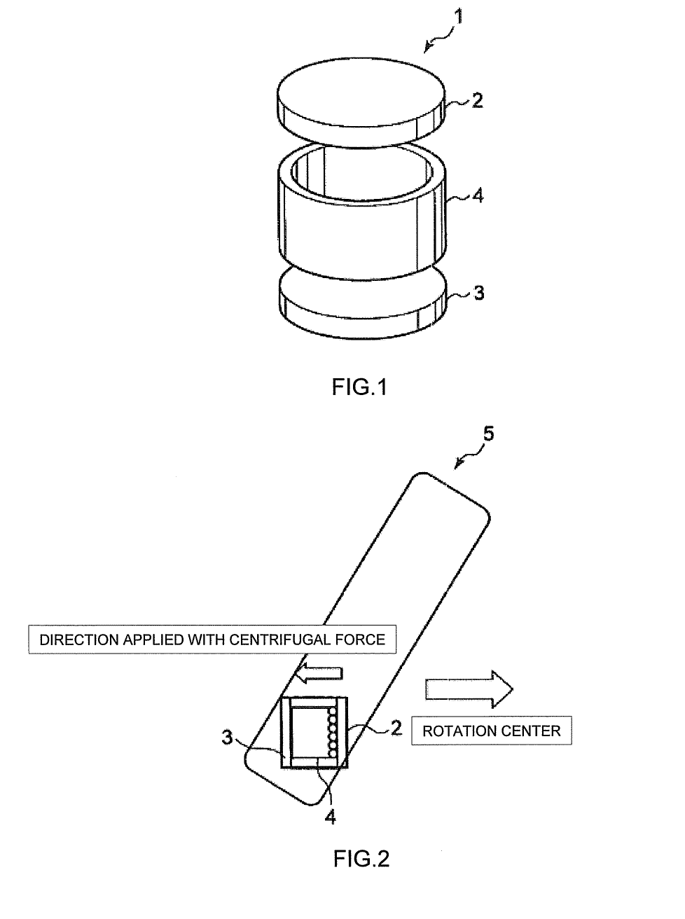

(2) The sheet to which the toner is attached to a sample set. As shown in FIG. 1, the sample set 1 includes a plate A 2, a plate B 3, and a cylindrical spacer 4. The outer diameter of the plate A 2, the plate B3, and the spacer 4 is 7 mm, the thickness of the spacer 4 is 1 mm, and the height thereof is 3 mm. The sheet to which the toner is attached is cut to have the size of the plate A 2 and then is attached to the surface of the plate A 2 coming in contact with the spacer with a double-sided tape.

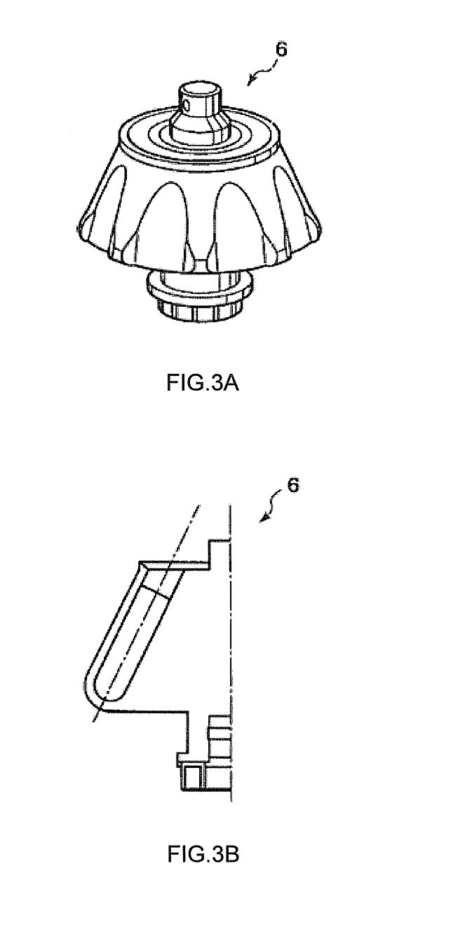

(3) As shown in FIG. 2, the sample set is placed into a cell 5. The cell 5 is placed into an angle rotor 6 shown in FIG. 3 so that the rear side of plate A 2 to which the sample is attached is directed to the rotation center and then the angle rotor 6 is mounted on an ultracentrifuge (not shown).

(4) After the ultracentrifuge is made to rotate at 10,000 rpm, the plates A and B are taken out and the toner particles attached thereto are separated therefrom with a mending tape and are attached to a white sheet of paper. The reflection density of the tape, which the toner is attached to, is measured with a Macbeth concentration meter.

(5) A correction formula of the reflection density for the toner quantity is independently prepared and the toner quantities separated and not separated are calculated in comparison with the correction formula.

(6) The sheet to which the toner is attached is cut and attached to the plate A as described in (2), and is placed into the ultracentrifuge as described in (3). Then, the ultracentrifuge is made to rotate at 20,000 rpm, the sample set is taken out as described in (4), and the toner quantities attached to the plates A and B are measured. This process is repeated up to 100,000 rpm every 10,000 rpm. The lowest number of rotations and set interval for the separation can be properly changed depending on the magnitude of the adhesive force and the breadth of the adhesive force distribution.

(7) The centrifugal acceleration RCF acting on the sample set into the cell by means of the rotation of the rotor is calculated by the following expression:

RCF=1.118×10⁻⁵×r×N²×g (2)

where r is a distance of the position of the sample set from the rotation center, N is the rotation speed rpm, and g is gravity acceleration. When the weight of one toner particle is m, the centrifugal force F acting on the toner particles is expressed by the following expression:

F=RCF×m (3)

m=(4/3)π×r³×ρ

where r is a sphericity equivalent radius and ρ is a specific weight of the toner. Accordingly, the sum of ones obtained by multiplying the centrifugal force F acting on the toner by a separated toner ratio every rotation number is used as the average adhesive force F (N) of the toner in the developer to the photoconductive member.

In measuring the average adhesive force F (N), the toner electrification quantity greatly affects the average adhesive force F (N). Accordingly, in order to measure the average adhesive force with high precision, it is preferable that the sample having the toner attached thereto is prepared in consideration of the actual process.

The average adhesive force F (N) measured in this way is expressed by the sum of the non-electrostatic adhesive force F₀ and the electrostatic adhesive force Fₑ. The electrostatic adhesive force Fₑ is proportional to the square of electrification quantity q per one toner particle.

F=Fₑ+F₀=K·q²+F₀ (4)

where K is a slope (proportional constant).

The non-electrostatic adhesive force F₀ can be obtained by varying a mixture ratio of the toner and the carrier, plotting q² on the X axis and the average adhesive force F on the Y axis, and linearly approximating the plot to calculate a y-intercept. It is preferable that the value of the non-electrostatic adhesive force F₀ is in the range of 1.5×10⁻⁸≦F₀≦1×10⁻⁷ N. When F₀ is smaller than or equal to 1.5×10⁻⁸ N, the adhesive force of the non-electrostatic toner to the photoconductive member is reduced, thereby causing the flying of the toner particles which cannot be controlled with an electric field. On the other hand, when F₀ is greater than or equal to 1×10⁻⁷ N, the necessary transfer electric field is too great, and other problems are caused such as the development is made difficult.

The average value Fₑ of the electrostatic adhesive force of the toner particles to the medium is calculated from the average adhesive force F (N) of the toner particles to the medium and the non-electrostatic adhesive force F₀ of the toner particles obtained as described above.

An electric field magnitude qE greater than the adhesive force F is required to move the toner particles by the use of the electric field E. That is, the necessary transfer electric field E is as follows:

E>F/q=K·q+F₀/q (5)

Accordingly, even when the movement of the toner particles not affected by the electric field is suppressed by increasing F₀, it is possible to suppress the necessary transfer electric field by the reducing slope K when the highly-electrified toner particles is used.

As described above, the necessary transfer electric field E with the variation in electrification quantity with the lapse of time or depending on the environment. The decrease in particle diameter causes a great variation of the electrification quantity Q/M per unit weight. The transfer residual or the inverse transfer is caused due to the toner particles not controlled by the electric field.

Generally, a particle size distribution and an electrification quantity distribution of the toner particles are required to be narrow to some extent. This is because the adhesive force or the particle size and the electrification quantity are usually controlled with average values thereof. When the particles exist which have the values remarkably different from the average values, the transfer residual or the inverse transfer is caused.

By reducing the slope K, it is not necessary to greatly vary the transfer electric field even when the toner electrification quantity varies and the adhesive force, the particle size or the electrification quantity are distributed. It is possible to suppress the transfer residual and the inverse transfer and thus to continuously stably control the cleaner-less process.

Accordingly, by suppressing the value of the slope K, it is possible to allow the high transfer efficiency and the stable transfer characteristic to be consistent with the high image quality.

It is known that the measured value of the electrostatic adhesive force of the toner particles is ten times or more the theoretical value of the electrostatic adhesive force of spherical particles which are used in general. For example, in Journal of Imaging Science and Technology vol. 48, No. 5, 2004, it is disclosed that the theoretical value Fi of the electrostatic adhesive force is expressed by the following expression:

Fi=α·q²/4πε₀D² (6)

where ε₀ is a dielectric constant in vacuum, α is a correction coefficient resulting from a difference in dielectric constant between the photoconductive member and the toner particles, q is a the electrification quantity of one toner particle, and D is a diameter of the toner particles, and that is, the difference of the measured value and the theoretical value is studied. The measured value was also theorized in Japan Hardcopy 2005, B-13. However, a theory for explaining the mechanism causing the difference between the measured value and the theoretical value was not yet constructed.

When it is assumed that the toner particles have sphericity and charges are located at the center of the spheres, an image force is expressed by the following expression:

$${F}_{e} = \frac{{ɛ}^{′} - 1}{{ɛ}^{′} + 1} \cdot \frac{{q}^{2}}{4 {πɛ}_{0}^{2}} \qquad ( 7 )$$

where ε′ is a specific dielectric constant of the image bearing member or the transport medium, q is an electrification quantity per one toner particle, and r is a volume average radius of the toner particles.

However, when the toner particles are formed by the use of the conventional crushing method, the toner particles are atypical. When the toner particles are formed by the use of the chemical method, the toner particles may be intentionally made into non-spherical shapes so as to improve usual cleaning performance. Since the toner particle (bulk) has a structure in which the wax for assisting fixing performance, the charge controlling agent (CCA), and the coloring agent are dispersed in a binder resin, the toner particle is not homogeneous. In addition, one or plural kinds of organic or inorganic particulates (external additive) are attached to the surfaces of the toner particles for the purpose of fluidity, assist of cleaning performance, and charge control.

In the toner particles, since both of the bulk and the surface have complex structures, the expression of the image force in which it is assumed that the toner particles have the sphericity and the charges are located at the center of the sphere is hardly matched. The measured value of the adhesive force is greater by one or two digits than the theoretical value calculated by the above-mentioned expression.

Therefore, the inventors found out that the actual adhesive characteristic could be better represented by the expression:

$${F}_{e} = \frac{{ɛ}^{′} - 1}{{ɛ}^{′} + 1} \cdot \frac{{q}^{2} {r}^{2}}{4 {{πɛ}_{0} ( {r}^{2} - {a}^{2} )}^{2}}$$

which is the expression in which a shift of the charge is assigned to expression 7 of the image force, with the assumption that the charges are located at a position shifted by a in the direction from the center to the contact point with the attached member such as the image bearing member and the transport medium, not at the center of the sphere with the radius of r.

When the toner is electrified, the charges exist in the charged sites on the surfaces of the toner particles (bulk), the external additives, and the like, and it cannot be said that the charges homogeneously exist on the surfaces. a/r can be used as an indicator indicating the irregularity. That is, as the charge distribution on the toner particles is more homogeneous, a/r gets closer to 0 and to the theoretical value when it is assumed that the charges are located at the center of the sphere. As the charge distribution is more non-homogeneous, the surface portions where the more charges exist come in contact with the attached members to generate the stronger image force. This state can be expressed by the increase in a/r.

a/r is calculated from the electrostatic adhesive force calculated by the measured average adhesive force as described above. The range of a/r is required to be 0.2≦a/r≦0.7.

When a/r gets close to 0, it is considered that the toner particles are almost spherical, material of the surface is homogenous, and the external additives almost completely cover the surface. The external additives serve to assist the fluidity in addition to control of the electrification. When the external additives are attached to almost completely cover the surfaces, the external additives are damaged in the function as fluidizer. Accordingly, a/r should be 0.2 or more.

On the other hand, when a/r exceeds 0.7 and gets close to 1, the slope K is shifted to increase in accordance with the following expression:

$${F}_{e} = \frac{{ɛ}^{′} - 1}{{ɛ}^{′} + 1} \cdot \frac{{r}^{2}}{4 {{πɛ}_{0} ( {r}^{2} - {a}^{2} )}^{2}} \qquad ( 8 )$$

When a/r exceeds 0.7 and the slope K increases, the margin of the optimal electrification quantity q of the toner gets smaller which indicates a low necessary transfer electric field when the non-electrostatic adhesive force is small. When the electrification quantity q varies, the necessary transfer electric field E varies drastically and thus it is difficult to maintain the high transfer efficiency. Accordingly, by setting a/r to 0.7 or less, the margin of the optimal toner electrification quantity q is sufficient and thus it is possible to allow the high transfer efficiency and the stable transfer characteristic to be consistent with the high image quality without varying the initially set transfer condition even when the electrification quantity varies.

Here, the electrification quantity q per one toner particle can be calculated using the electrification quantity Q per weight (μC/g) as follows:

q=(4/3)πr³xd×Q (9),

where r is a volume average radius of the toner particles and d is a specific weight of the toner particles. The before-transfer electrification quantity of toner Q (μC/g) is preferably in the range of −20 to −80 μC/g. When the electrification quantity is smaller than −20 μC/g, the control of the toner, particularly a small particle diameter using an electric field is difficult. Accordingly, the toner particles fly outside the developing device with the centrifugal force due to the rotation of the developer bearing member or contaminates a non-image area on the photoconductive member. When the electrification quantity is greater than −80 μC/g, it is difficult to supply a sufficient amount of toner to the electrostatic latent image, thereby not obtaining an image with high density.

When a higher precision control of the adhesive force is necessary such as when the cleaner-less process is applied to a 4-drum tandem process used for a full color image forming apparatus, it is necessary to control the electrification quantity within a narrower range and preferably in the range of −25 to −50 μC/g.

The volume average radius r of the toner particles is preferably in the range of 1.5 to 4 μm. When the volume average radius is smaller than 1.5 μm, the electrification quantity per weight gets too great by giving the electrification quantity, which can be controlled by the electric field, to the toner particles, thereby making it difficult to obtain the desired development quantity. When the volume average radius is greater than 4 μm, the reproducibility of a fine image and the granular property is deteriorated. The volume average radius is more preferably in the range of 2 to 3 μm.

An image is formed, for example, in the following electrophotographic process by the use of the image forming method, the image forming apparatus, or the developer which is described above.

### 2-Component Developing Process

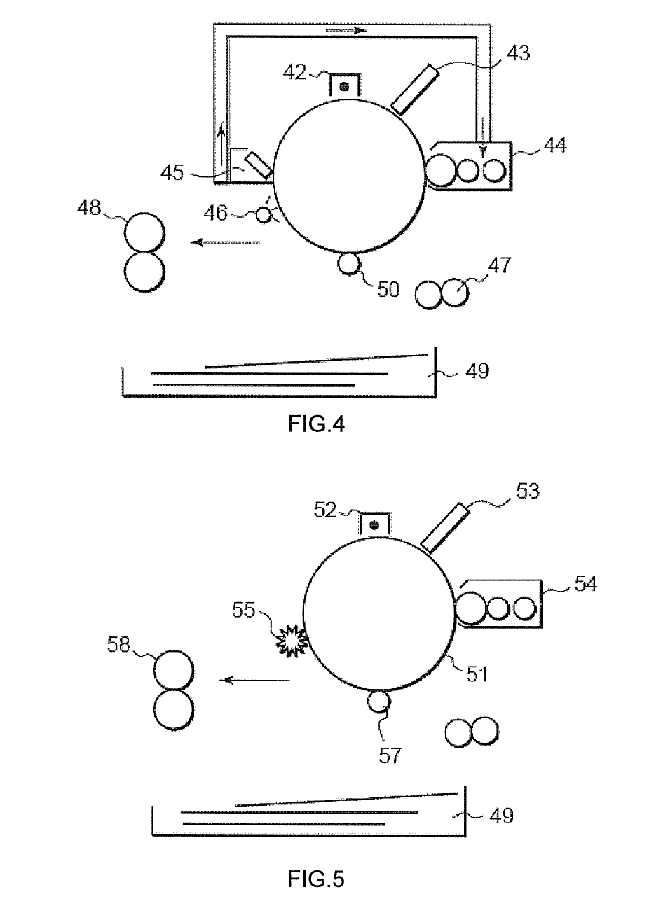

An image forming apparatus using a 2-component developing process is shown in FIG. 4. As shown in the figure, a photoconductive member 41, a charging device 42 for charging the photoconductive member, an exposure device 43 for forming an electrostatic latent image, a developing device 44 for supplying toner particles to the electrostatic latent image, a cleaner 45 for removing the transfer residual toner, a charge removing lamp 46 for removing the electrostatic latent image, a paper fed device 47 for supplying a sheet of paper which is the final transfer medium, a fixing device 48 for fixing the toner image onto the sheet of paper, and a transfer device 50 for transferring the toner image on the photoconductive member 41 onto the transfer medium 49 are disposed. An image is formed on the transfer medium 49 in the following processes by the use of the above-mentioned image forming apparatus.

The photoconductive member 41 such as a belt and a roller is homogeneously charged to a desired potential by a known charging device 42 like a corona charger such as a charger wire, a comb charger, a scorotron, a contact charging roller, a non-contact charging roller, a solid charger, and a contact charging brush.

Known photoconductor member such as organic photoconductor (OPC) electrified in plus or minus and amorphous silicon is used for the photoconductive member 41. In the photoconductive member, a charge generating layer, a charge transport layer, and a protective layer may be stacked or a layer having functions of plural layers of these layers may be formed.

By performing an exposure process by the use of the exposure device 43 employing known means such as a laser and an LED, an electrostatic latent image is formed on the photoconductive member 41.

In the developing device 44, 100 g to 700 g of a 2-component developer including a carrier and toner particles is placed in a hopper. The developer is transported to the development roller enclosing a magnetic roller by an agitating auger and the electrified toner particles are supplied and attached to the electrostatic latent image on the photoconductive member 41 by the use of a magnetic brush phenomenon, thereby developing the latent image. At this time, a DC developing bias or a developing bias in which AC is overlapped with DC is applied to the development roller so as to form an electric field for homogeneously and stably attaching the toner particles thereto.

The toner particles not developed get away from the development roller at the separation pole position of the magnetic roller and are collected into the developer storing container with the agitating auger. A known toner concentration sensor is mounted on the developer storing container. when the concentration sensor senses the decrease in toner quantity, a signal is sent to a toner replenishment hopper and new toner is replenished. At this time, the toner consumption may be presumed from the integration of printing data or/and the sensing of the toner quantity on the photoconductive member and the new toner may be replenished based on the result. Both the sensor output means and the consumption presuming means may be used.

The formed toner image is disposed to come in contact with the photoconductive member 41 and is transferred to the transfer medium 49 such as a sheet of paper via the intermediate transfer member such as a belt and a roller or directly by the use of the known transfer means such as a transfer roller, a transfer blade, and a corona charger for transferring the toner image with a transfer voltage applied thereto.

The transfer medium 49 onto which the toner image is transferred is separated from the intermediate transfer medium or the photoconductive member 41, is transported to a fixing unit 48, the toner image is fixed to the transfer medium 49 by known heating and pressurizing fixing means such as a heating roller, and then is discharged out of the machine.

After the toner image is transferred, the transfer residual toner remaining without being transferred onto the photoconductive member 41 is removed by the cleaner 45 and the electrostatic latent image on the photoconductive member 41 is deleted by the charge removing lamp 46.

The transfer residual toner removed by the cleaner 45 is stored in a waste toner box via a transport path by the agitating auger and then is discharged. In a recycle method, the transfer residual toner is collected into the developer storing container of the developing device 44 from the transport path and is recycled.

### 1-Component Developing Process

In the 1-component developing process, an image is formed in the similar way by the similar image forming apparatus as the 2-component developing process, but the developing device part is different therefrom. Only toner particles are injected into the developing device and the image is developed without using a carrier.

The toner particles are supplied to the surface of the developer bearing member such as an elastic roller having a conductive rubber layer on the surface thereof or a metal roller made of SUS or the like having roughness on the surface thereof resulting from a sand blast or the like, by a known structure such as a transport auger and an intermediate transport sponge roller. The toner particles supplied to the surface of the developer bearing member is frictionally electrified by a toner electrifying member such as silicone rubber, fluorine rubber, and metal blade pressed onto the surface of the developer bearing member. At this time, the toner electrified in advance by the friction with the magnetic particles may be supplied to the developer bearing member. The photoconductive member is in contact with the developer bearing member or is faced apart by a defined gap the developer bearing member. The photoconductive member rotates with a speed difference to develop the toner particles. At this time, in order to form an electric field for homogeneously and stably attaching the toner particles, a DC developing bias or a developing bias with AC overlapped with DC is applied to the development roller.

### Cleaner-Less Process

In the cleaner-less process, an image is formed in the similar way by the similar image forming apparatus as the 2-component developing process, but the cleaner is omitted as shown in FIG. 5. The transfer residual toner is collected at the same time as the development without using the cleaner.

Similarly to the 2-component developing process, the photoconductive member 51 is developed by charging and exposing the photoconductive member and attaching the toner particles thereto, the toner image is transferred onto the transfer medium 59 through the intermediate transfer member or directly. In FIG. 5, the transfer is performed by the transfer roller 57 using of a direct transfer method. The transfer residual toner remaining in the non-image portion is transported again to the development area through the charge removing process, the charging process by the charger 52, and the exposure process by the exposure device 53 in the state where the transfer residual toner remains on the photoconductive member 51. The transfer residual toner is collected into the developing device 54 by a magnetic brush which is the developer bearing member and is newly developed.

At this time, a memory disturbing member 55 such as a fixed brush, a pelt, a rotating brush, and a lateral sliding brush may be disposed before or after the charge removing process. A temporary collection member may be disposed to temporarily collect the transfer residual toner, to discharge the collected toner onto the photoconductive member 51 again, and then collect the discharged toner to the developing device 54. A toner electrification device may be disposed on the photoconductive member 51 so as to set the electrification quantity of the transfer residual toner to a desired value. A part or all of the toner electrification device, the memory disturbing member, the temporary collection member, and the charger may be performed by a single member. In order to efficiently perform the functions, a DC and/or AC voltage in plus or minus may be applied.

For example, front ends of two lateral sliding brushes for performing all the three functions are disposed between a transfer area and the charging member of the photoconductive member 51 so as to come in contact with the photoconductive member 51. A voltage having the same polarity as the developing toner charges is applied to the upstream brush and a voltage having the polarity different from that of the developing toner charges is applied to the downstream brush.

The toner particles having different polarities of charges and the same polarity of very high charges are mixed in the transfer residual toner. The toner particles coming in contact with the same-polarity brush and having the polarity different from that of the brush are inverted in charges and passed through, or are temporarily collected into the brush. The transfer residual toner reaching the downstream brush having the different polarity having the same polarity as the development toner and the like-polarity strong charges are alleviated and passed through by coming in contact with the brush having the different polarity or is temporarily collected into the brush.

The transfer residual toner having a small amount of charges and losing an image structure due to a mechanical contact with the brush is electrified in a non-contact manner by the electrification member of the photoconductive member 51 along with the photoconductive member 51 and thus has the same electrification quantity as the development toner. Accordingly, in the developing area, the transfer residual toner of the non-image portion in a new latent image is collected into the developing device 54 and the transfer residual toner of the image portion is transferred onto the transfer medium along with the toner particles newly supplied from the developing device 54.

### 4-Drum Tandem Process

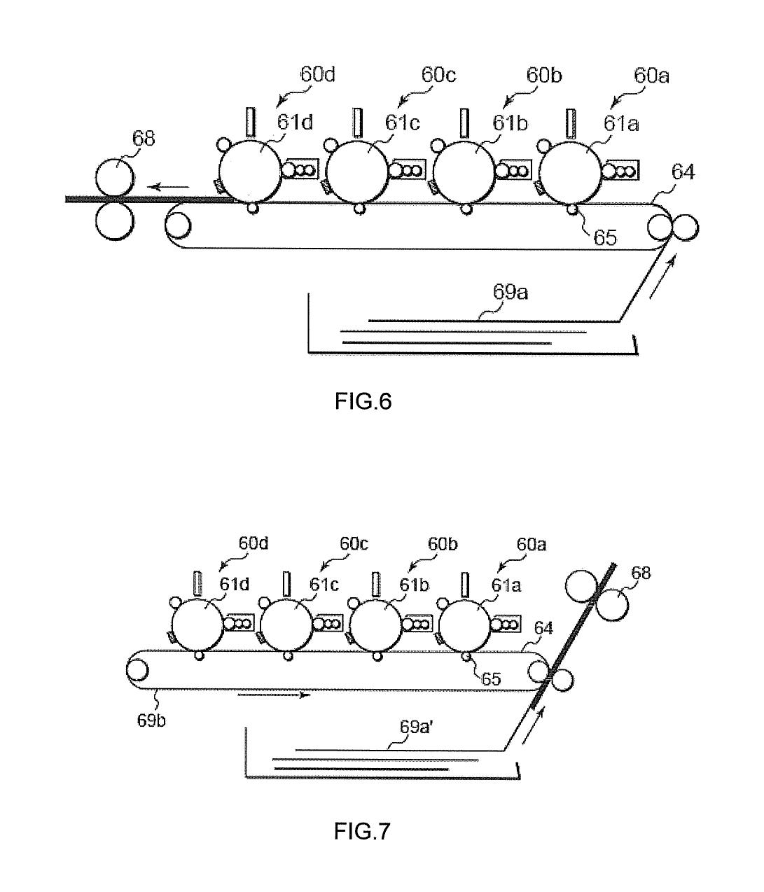

An image forming apparatus employing a 4-drum tandem process is shown in FIG. 6. As shown in the figure, image forming units 60a, 60n, 60c, and 60d including a developing device having corresponding color toner particles of yellow, magenta, cyan, and black, a photoconductive member, a charger, an exposure device, and a transfer device are provided to correspond to 4 colors and are arranged in parallel along the transport path of the transfer medium 69a. Similarly to FIG. 4, a fixing device 68 is disposed for fixing the toner image onto a sheet of paper. An image is formed in the following processes by the use of the above-mentioned image forming apparatus. Here, it is exemplified that yellow, magenta, cyan, and black are arranged in this order.

In the yellow image forming unit, a yellow toner image is formed on the photoconductive member 61a and is transferred onto a transfer medium 69a. In the direct transfer, a sheet of paper or the like which is the final transfer medium is transported by a transport member such as a transfer belt or a roller and is fed to the transfer area of the yellow image forming unit. In FIG. 6, a transfer roller 65 performs the transfer process on the sheet of paper transported by the transfer belt 64 as the transport member. At this time, the volume resistance of the transfer belt is preferably in the range of 10⁷ Ωcm to 10¹² Ωcm. Rubber-based materials such as ethylene propylene rubber (EPDM) and chloroprene rubber (CR) or resin-based materials such as polyimide, polycarbonate, polyvinylidene difluoride (PVDF), ethylene tetrafluoro ethylene (ETFE) are used as a material of the transfer belt. The transfer belt can constructed from one or plural layers of a resin sheet, a rubber elastic layer, and a protective layer and the like. The transfer method can be performed using known transfer means such as a transfer roller, a transfer blade, and a corona charger.

At the transfer position, a transfer bias voltage having predetermined magnitude and polarity from a transfer bias power supply is supplied from the transfer roller 65 disposed to press the transfer belt 64 in contact with the photoconductive member 61a toward the photoconductive member 61a to the transfer medium 69a located between the transfer belt 64 and the photoconductive member 61a. With the supply of the transfer bias voltage, the toner image (toner) electrostatically attached to the outer peripheral surface of the photoconductive member 61a is attracted to the transfer medium 69a and is transferred to the transfer medium 69a.

As shown in FIG. 7, an intermediate transfer belt 69b may be provided as the intermediate transfer medium. The intermediate transfer belt 69b has a semi-conductive property and is formed of a resin member, a rubber member, or a stacked member thereof having a thickness of 50 to 3,000 μm. The transfer roller 65 (transfer means) is in contact with the rear surface of the belt opposed to the photoconductive member 61a. A predetermined transfer bias voltage is applied to the transfer roller 65 by a transfer bias voltage application unit, thereby forming a transfer electric field in a transfer nip portion in which the photoconductive member 61a is in contact with the intermediate transfer belt 69b or in the vicinity thereof.

In this embodiment, by bringing the transfer roller 65 using a semi-conductive sponge having volume resistivity in the range of 10⁵ Ωcm to 10⁹ Ωcm into contact with the rear surface of the belt and applying a DC voltage of 300 V to 3,000 V thereto, the toner image on the photoconductive member of the respective process units is transferred to the intermediate transfer belt 69b. Four process units are arranged to perform the transfer process in the overlap manner, thereby forming a full color image. Thereafter, the full color image is transferred to the transfer medium 69a′ such as a sheet of paper at a secondary transfer position and is heated and fixed thereto by the fixing device 68, thereby forming the final image.

The same material as the above-mentioned transfer belt 64 is used as the material of the intermediate transfer belt. The surface resistance is preferably in the range of 10⁷ Ωcm to 10¹² Ωcm and for example, 10⁹ Ωcm.

In the magenta image forming unit 60b, similarly, a magenta toner image is formed on the photoconductive member 61b, the transfer medium 69a onto which the yellow toner image is formed previously is fed to the transfer area of the magenta image forming unit 60b, and the magenta toner image is transferred onto the yellow toner image with the positions matched with each other. At this time, the yellow toner on the transport medium may be inversely transferred to the magenta photoconductive member 61b by coming in contact with the magenta photoconductive member 61b depending on the toner electrification quantity and the strength of the transfer electric field.

In the cyan and black image forming units 60c and 60d, similarly, toner images are formed and sequentially transferred onto the transfer medium 69a in the overlap manner. The toner at the previous stages may be also inversely transferred onto the cyan and black photoconductive members 61c and 61d.

The transfer medium 69a on which four color toner images are formed in the overlap manner is separated from the transport member, is transported to the fixing device 68, is subjected to the fixing process by the known heating and pressing fixing method using a heating roller and the like, and is discharged out of the machine. When the intermediate transfer medium 69b is used, four color toner images are arranged and transferred to the final transfer medium 69a′ such as a sheet of paper fed to the secondary transfer means by the feeding member. Thereafter, the final transfer medium is transported to the fixing device 68, is subjected to the fixing process, and is discharged out of the machine.

In the image forming units, the charges are removed from the photoconductive members 61a, 61b, 61c, and 61d, similarly to the 2-component developing process, the transfer residual toner and the inversely transferred toner are removed by the cleaning process, and then the flow is returned to the image forming process again. In the developing device the toner ratio concentration is adjusted, similarly to the 2-component developing process mentioned above. Although it has been exemplified herein that the image forming units are arranged in the order of yellow, magenta, cyan, and black, the invention is not particularly limited to this color order.

### 4-Drum Tandem Cleaner-Less Process

In the 4-drum tandem cleaner-less process, an image is formed in the similar way by the similar image forming apparatus as the 4-drum tandem process, but the cleaner is omitted as in the above-mentioned cleaner-less process.

Similarly to the cleaner-less process, the transfer residual toner and the inversely-transferred toner are adjusted in electrification quantity and are collected at the same time as the development without using the cleaner.

In the developing processes described above, it is possible to prevent the ozone deterioration of a photoconductive layer of the photoconductive members and thus to elongate the lifetime of the photoconductive members by employing a contact type charger.

The corona charger which is the non-contact type charger is widely used to charge the photoconductive member. However, since the corona charger generates a large amount of ozone, a bad smell or a deterioration of the surface of the photoconductive member occurs. On the other hand, it is possible to suppress the influence of ozone by filtering off the bad smell and gradually removing the deteriorated layer by the use of a cleaning blade or the like. However, when the amount of wear exceeds a predetermined amount, the photoconductivity is damaged, thereby shortening the life of the photoconductive member. On the contrary, advantageously, the contact type charger does not generate ozone.

For example, a charging roller having at least an elastic layer made of ion conductive rubber, carbon-dispersed rubber, or the like and a volume resistance in the range of 10⁴ Ωcm to 10⁸ Ωcm is used as the charger. The charging roller is brought into contact with the photoconductive member with a predetermined pressure to rotate along with the photoconductive member or is made to rotate at a speed equal to or slightly different from the speed of the photoconductive member. At this time, by applying a DC voltage of 400 to 1000 V to a charging roller spindle, electric charges can be injected into the surface of the photoconductive member to charge the surface of the photoconductive member to a predetermined potential.

When applying the contact type charger to the cleaner-less process, the transfer residual toner may remain on the photoconductive member at the time of electrification. In performing the cleaner-less tandem process, the inversely transferred toner may remain on the photoconductive member at the time of electrification, in addition to the transfer residual toner. Accordingly, a web, a brush, or a blade for cleaning the charging roller is preferably always or properly in contact therewith.

Hereinafter, the invention will be specifically described with reference to examples.

In examples and comparative examples described below, a particle size distribution measuring device (BECKMAN COULTER COUNTER MULTISIZER 3) was used to measure the volume average diameter of the toner particles.

In measuring circularity of the toner particles, by using a flow type particle analyzing system FPIA-3000 made by Sysmex Corporation, the circularity=D1/D2 (=1 in circularity (=sphericity)) is obtained, when it is assumed that a peripheral length calculated from a diameter of a true circle corresponding to the same area as a projection area of a particle is D1 and a peripheral length of a projection particle is D2.

In measuring the transfer efficiency, a non-transferred toner quantity T2 after being transferred to the transfer medium relative to the toner development quantity T1 on the photoconductive member (for example, 300 μg/cm²) is measured by using the image forming apparatus using the 2-component developing process shown in FIG. 4, thereby calculating the transfer efficiency from the following expression:

Transfer efficiency=(T1−T2)/T1.

At this time, the toner quantity on the photoconductive member is calculated by sucking the toner in a predetermined area to measure the weight of the toner, measuring a reflection density of the toner separated by a tape and attached to a blank sheet with a Macbeth concentration meter, and applying the values to the previously prepared correction formulas of the reflection density and the toner quantity to calculate the toner quantity and the like.

### EXAMPLE 1

### Preparation of Toner Particle

The toner particles were formed as follows.

First, 28 wt % of polyester resin as a resin, 7 wt % of carmine 6B as a coloring agent, 5 wt % of rice wax, and 1 wt % of carnauba wax as a release agent were kneaded by Kneadex made by YPK to prepare a masterbatch. The masterbatch was roughly ground, 59 wt % of polyester resin and 1 wt % of CCA (TN105) were added thereto, and the mixture was kneaded. Particulates having a volume average particle size of 5.0 μm were formed by roughly grinding and then finely grinding the resultant structure and then cutting out particles having a particle size of 7 μm or more and 3 μm or less by an elbow jet classification.

Particulates of Resin such as acrylic and methacrylic having a particle size of 1 μm or less were mixed into 100 wt % of the particulates mentioned above so that a coating rate is about 100%. At this time, when the particle size of the resin particulates is 0.1 μm, the amount of the resin particulates is about 8 wt %. The resultant mixture was subjected to a mechanochemical process (hybridization system of Nara Machinery CO., LTD.), thereby forming encapsulated particles (toner mother particles) in which resin particulates are melted and fixed to the surfaces of the particulates.

Next, based on 100 wt % of the encapsulated particles, 1.5 wt % of silica (R974: made by Japan Aerosil CO., LTD.) having an average particle size of 12 nm, 1.5 wt % of silica (X-24: made by Shin-Etsu Chemical CO., LTD.) having an average particle size of 100 nm, and 0.3 wt % of titanium oxide (NKT90: made by Titan Kogyo CO., LTD.) were attached to the surfaces thereof by the use of Henschel mixer, thereby forming the toner particles.

The pointed portions formed by the grinding process are slightly rounded due to impacts or frictions at the time of performing the mechanochemical process and the finally obtained toner particles had a volume average diameter of 6.3 μm and circularity of 0.94.

The resultant toner particles were mixed with carriers in which spherical ferrite particles having a volume average diameter of 40 μm are coated with a silicone resin, thereby preparing the 2-component developer. The average adhesive force F (N) of the toner particles to the transport medium (photoconductive sheet with a dielectric constant of ε′=3.3) was measured in the state where about 300 μg/cm² of the toner particles are developed on the transport medium every unit electrification quantity while changing the electrification quantity of the toner particles by changing the mixture ratio.

By plotting the average adhesive force F on the vertical axis, plotting q² on the horizontal axis, and then linearly approximating the resultant plot, F₀=4×10⁻⁸ (N) and K=9.64×10²⁰ (N/C²) was calculated from the following expression:

F=Fₑ+F₀=K·q²+F₀ (4).

a/r of the resultant toner particles was 0.54 from the following expression when r=6.3 μm/2=3.15 μm.

$${F}_{e} = \frac{{ɛ}^{′} - 1}{{ɛ}^{′} + 1} \cdot \frac{{q}^{2} {r}^{2}}{4 {{πɛ}_{0} ( {r}^{2} - {a}^{2} )}^{2}} \qquad$$

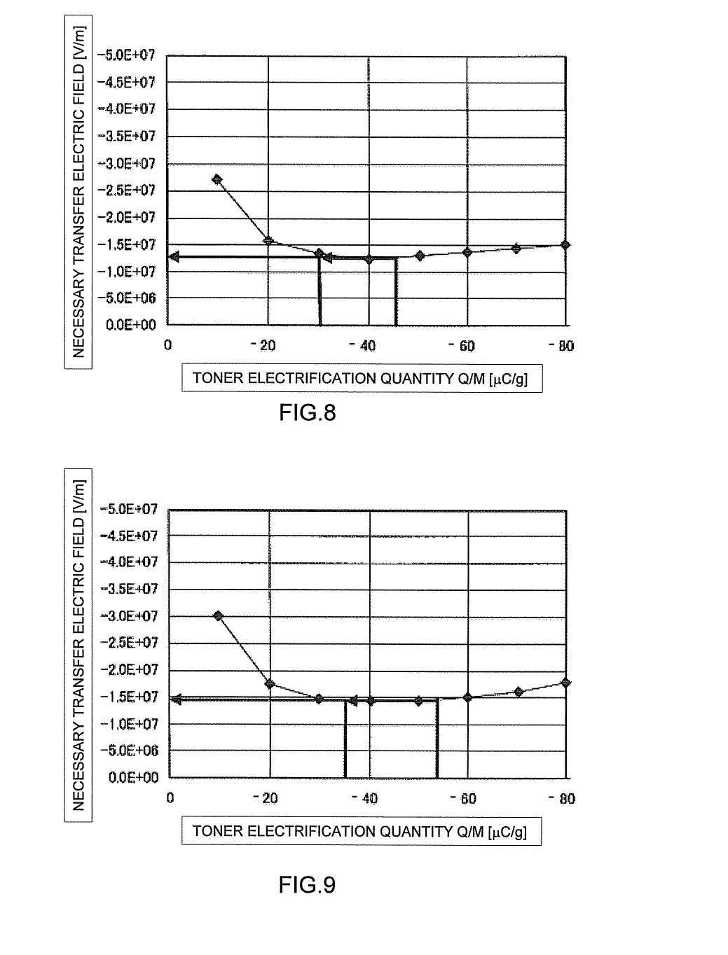

The dependency of the necessary transfer electric field E on the electrification quantity in the resultant toner particles is shown in FIG. 8. As shown in the figure, it can be seen that the variation in necessary transfer electric field E is small in the range of −20 to 80 μC/g and it is thus possible to obtain excellent characteristics.

This is considered to be because the homogeneity of the electrification distribution could be improved by rounding the toner mother particles due to the impact or friction at the time of performing the mechanochemical process, further adding external additives thereto to reduce the non-electrostatic adhesive force, and coating the toner mother particles with the binder resin to homogenize the surfaces.

### Estimation of Transfer Efficiency and Electrification Quantity

The resultant toner particles were mixed with the carriers obtained by coating the spherical ferrite particles having a volume average diameter of 40 μm with silicone resin at a toner particle ratio of 7 wt %, the mixture was provided to an electrophotographic process, and then the variations in transfer efficiency and electrification quantity with the lapse of time were estimated with the acceleration.

When the volume resistance of the intermediate transfer belt in the printer is 10⁹ Ωcm and the initial environmental condition is the normal temperature and normal humidity environment, the transfer efficiency with the toner electrification quantity of −45 μC/g and the optimal transfer bias voltage of 600 V was 98%, which was excellent.

When the printing operation was performed on 60K pcs at a printing rate of 6% and the printer was left in an environment of a temperature of 32° C. and humidity of 80%, the toner electrification quantity was changed to −30 μC/g, but the transfer efficiency was 98%.

This is considered to be because the necessary transfer electric field hardly varies even with the variation in toner electrification quantity from −45 μC/g to −30 μC/g as shown in FIG. 8. Since the transfer efficiency is not deteriorated due to the variations with the lapse of time and in environment, the image quality could be maintained in the initial excellent state.

Since the high transfer efficiency and the high image quality could be maintained without controlling the transfer bias condition, it was not necessary to change the transfer bias. Accordingly, a control sequence of changing the transfer condition on the basis of the toner electrification quantity for controlling the transfer electric field and the sensor output of an environmental temperature and humidity sensor is not necessary.

When the toner particles were applied to the cleaner-less image forming apparatus, the transfer efficiency did not vary with the variations with the lapse of time and in environment and thus the transfer residual toner could be kept small. Accordingly, it is possible to maintain the high image quality without any image defect such as negative memory and positive memory specific to the cleaner-less process.

### EXAMPLE 2

### Preparation of Toner Particle

The toner particles were formed as follows.

First, polyester-based prepolymer was dissolved in an organic solvent, 7 wt % of carbon black as a coloring agent, 2 wt % of stearic acid as a release agent, and 0.1 wt % of benzoyl peroxide as an polymerization initiator were dispersed in the solvent. The solvent was placed in an aqueous solvent and emulsified. Particulates having the homogeneity of the size distribution including a resin, a coloring agent, and a release agent were formed by heating the resultant solution while agitating the resultant solvent.

Encapsulated particles (toner mother particles) having a volume average diameter of 5.2 μm were formed by adding prepolymer to the solvent, polymerizing the resultant solution so as to coat the particulates therewith, and then removing the solvent and drying. The circularity was 0.95.

Next, based on 100 wt % of the encapsulated particles, 2 wt % of silica (R974: made by Japan Aerosil CO., LTD.) having an average particle size of 12 nm, 1.8 wt % of silica (X-24: made by Shin-Etsu Chemical CO., LTD.) having an average particle size of 100 nm, and 0.3 wt % of titanium oxide (NKT90: made by Titan Kogyo CO., LTD.) were attached to the surfaces thereof by the use of Henschel mixer, thereby forming the toner particles having a volume average diameter of 5.2 μm.

As in Example 1, the resultant toner particles were mixed with carriers in which spherical ferrite particles having a volume average spherical diameter of 40 μm are coated with a silicone resin, thereby preparing the 2-component developer. The average adhesive force F (N) of the toner particles to the transport medium (photoconductive member with a dielectric constant of ε′=3.3) was measured every unit electrification quantity while changing the electrification quantity of the toner particles by changing the mixture ratio.

As in Example 1, by plotting the average adhesive force F on the vertical axis, plotting q² on the horizontal axis, and then linearly approximating the resultant plot, F₀=2.5×10⁻⁸ (N) and K=2.03×10²¹ (N/C²) were calculated. As in Example 1, a/r of the resultant toner particles was 0.64 on the basis of the value of K when r=5.2 μm/2=2.6 μm.

The dependency of the necessary transfer electric field E on the electrification quantity in the resultant toner particles is shown in FIG. 9. As shown in the figure, it can be seen that the variation in necessary transfer electric field E is small in the range of −20 to −80 μC/g and it is thus possible to obtain excellent characteristics.

This is considered to be because the homogeneity of the electrification distribution could be improved by rounding the toner mother particles by the use of the emulsion polymerization process, further adding external additives thereto to reduce the non-electrostatic adhesive force, and coating the toner mother particles with the binder resin to homogenize the surfaces.

### Estimation of Transfer Efficiency and Electrification Quantity

The resultant toner particles were mixed with the carriers obtained by coating the spherical ferrite particles having a volume average diameter of 40 μm with silicone resin at a toner particle ratio of 6 wt %, the mixture was provided to an electrophotographic process, and then the variations in transfer efficiency and electrification quantity with the lapse of time were estimated with the acceleration.

When the volume resistance of the intermediate transfer belt in the printer is 10⁹ Ωcm and the initial environmental condition is the normal temperature and normal humidity environment, the transfer efficiency with the toner electrification quantity of −53 μC/g and the optimal transfer bias voltage of 700 V was 99% which was excellent.

As in Example 1, when the printing operation was performed on 60K pcs at a printing rate of 6% and the printer was left in an environment of a temperature of 32° C. and humidity of 80%, the toner electrification quantity was changed to −35 μC/g, but the transfer efficiency was 98%.

This is considered to be because the necessary transfer electric field hardly varies even with the variation in toner electrification quantity from −53 μC/g to −35 μC/g as shown in FIG. 9. Since the transfer efficiency hardly deteriorated with the lapse of time and the variation in environment, the image quality could be maintained in the initial excellent state.

As in Example 1, since the high transfer efficiency and the high image quality could be maintained without controlling the transfer bias condition, it was not necessary to change the transfer bias. Accordingly, a control sequence and the like therefor were not necessary.

As in Example 1, when the toner particles were applied to the cleaner-less image forming apparatus, the transfer efficiency did not vary with the lapse of time and with the variation in environment and thus the transfer residual toner could be kept small. Accordingly, it is possible to maintain the high image quality without any image defect such as negative memory and positive memory specific to the cleaner-less process.

### EXAMPLE 3

### Preparation of Toner Particle

The toner particles were formed as follows.

First, 28 wt % of polyester resin as a resin, 6 wt % of carbon black as a coloring agent, and 6 wt % of rice wax as a release agent were kneaded by Kneadex made by YPK to prepare a masterbatch. The masterbatch was roughly ground, 60 wt % of polyester resin and 1 wt % of CCA (TN105) were added thereto, and the mixture was kneaded. Particulates having a volume average particle size of 6.0 μm were formed by roughly grinding and then finely grinding the resultant structure and then cutting out particles having a particle size of 8 μm or more and 3 μm or less by an elbow jet classification.

The particulates are rounded by heating and based on 100 wt % of the encapsulated particles, 1.5 wt % of silica (R972: made by Japan Aerosil CO., LTD.) having an average particle size of 16 nm, 1.3 wt % of silica (X-24: made by Shin-Etsu Chemical CO., LTD.) having an average particle size of 100 nm, and 0.5 wt % of aluminum oxide (Al₂O₃: made by NanoTech) were attached to the surfaces thereof by the use of Henschel mixer, thereby forming the toner particles.

The pointed portions formed by the grinding process were rounded by heating and the finally obtained toner particles had a volume average diameter of 6.0 μm and circularity of 0.96.

As in Example 1, the resultant toner particles were mixed with carriers in which spherical ferrite particles having a volume average diameter of 40 μm are coated with a silicone resin, thereby preparing the 2-component developer. The average adhesive force F (N) of the toner particles to the transport medium (photoconductive member with a dielectric constant of ε′=3.3) was measured every unit electrification quantity while changing the electrification quantity of the toner particles by changing the mixture ratio.

As in Example 1, by plotting the average adhesive force F on the vertical axis, plotting q² on the horizontal axis, and then linearly approximating the resultant plot, F₀=2.5×10⁻⁸ (N) and K=2.11×10²¹ (N/C²) were calculated. As in Example 1, a/r of the resultant toner particles was 0.70 on the basis of the value of K when r=6.0 μm/2=3.0 μm.

The dependency of the necessary transfer electric field E on the electrification quantity in the resultant toner particles was excellent. This is considered to be because the electrostatic adhesive force could be reduced by a spacer effect of the external additives by rounding the toner mother particles by heating and further adding external additives thereto to reduce the non-electrostatic adhesive force.

### Estimation of Transfer Efficiency and Electrification Quantity

The resultant toner particles were mixed with the carriers obtained by coating the spherical ferrite particles having a volume average diameter of 40 μm as described above with silicone resin at a toner particle ratio of 6 wt %, the mixture was provided to an electrophotographic process, and then the variations in transfer efficiency and electrification quantity with the lapse of time were estimated with the acceleration.

When the volume resistance of the intermediate transfer belt in the printer is 10⁹ Ωcm and the initial environmental condition is the normal temperature and normal humidity environment, the transfer efficiency with the toner electrification quantity of −40 μC/g and the optimal transfer bias voltage of 750 V was 98%, which was slightly excellent.

As in Example 1, when the printing operation was performed on 60K pcs at a printing rate of 6% and the printer was left in an environment of a temperature of 32° C. and humidity of 80%, the toner electrification quantity was changed to −23 μC/g, but the transfer efficiency was 96%.

This is considered to be because the necessary transfer electric field hardly varies even with the variation in toner electrification quantity from −40 μC/g to −23 μC/g. Since the transfer efficiency is not deteriorated due to the variations with the lapse of time and in environment, the image quality could be maintained almost in the initial excellent state.

### EXAMPLE 4

### Preparation of Toner Particle

The toner particles were formed as follows.

First, 20 wt % of a mixture of styrene monomer and methacryl n-butyl monomer at a ratio of 6:4 and 1 wt % of nonionic surfactant (polyethylene oxide) as an emulsifier were taken in water in which 0.5 wt % of potassium persulfate is dispersed as a polymerization initiator and the resultant solution was heated and agitated, thereby forming an aqueous dispersion of emulsified polymer particulates having a particle size of 1 μm or less. Other aqueous dispersion in which carbon black as a coloring agent and rice wax as a release agent are finely dispersed in water was prepared. Both of the aqueous dispersions were mixed so as to include 69 wt % of a resin, 8 wt % of a coloring agent, and 3 wt % of a release agent and were aggregated to 3 to 4 μm of the particle diameter using a metal salt as an aggregating agent, thereby forming mixture particles in which the resin, the coloring agent, and the release agent are mixed. By agitating the resultant particles while heating the particles at a temperature higher than the glass transition point, the mixed particles were fused.

A mixture in which 1 wt % of CCA (TN105) based on the entire solid was dispersed in the aqueous dispersion of resin particles was taken in the dispersion of the fused mixture particles and the particles were aggregated so as to coat the fused mixture particles with the resin particulates. By heating and agitating the resultant particles, the resin particulates were melted and fixed. By cleaning and drying the resultant particles, encapsulated particles (toner mother particles) having a volume average diameter of 5.8 μm were formed. The circularity was 0.97.

Next, based on 100 wt % of the encapsulated particles, 1.5 wt % of silica (R972: made by Japan Aerosil CO., LTD.) having an average particle size of 16 nm, 1.5 wt % of silica (X-24: made by Shin-Etsu Chemical CO., LTD.) having an average particle size of 100 nm, and 0.6 wt % of titanium oxide (NKT90: made by Titan Kogyo CO., LTD.) were individually taken in the Henschel mixer and were sequentially attached to the surfaces thereof, thereby forming the toner particles having a volume average diameter of 5.8 μm and circularity of 0.97.

As in Example 1, the resultant toner particles were mixed with carriers in which spherical ferrite particles having a volume average diameter of 40 μm are coated with a silicone resin, thereby preparing the 2-component developer. The average adhesive force F (N) of the toner particles to the transport medium (photoconductive member with a dielectric constant of ε′=3.3) was measured every unit electrification quantity while changing the electrification quantity of the toner particles by changing the mixture ratio.

As in Example 1, by plotting the average adhesive force F on the vertical axis, plotting q² on the horizontal axis, and then linearly approximating the resultant plot, F₀=3.2×10⁻⁸ (N) and K=7.95×10²⁰ (N/c²) were calculated. As in Example 1, a/r of the resultant toner particles was 0.39 on the basis of the value of K when r=5.8 μm/2=2.9 μm.

The dependency of the necessary transfer electric field E on the electrification quantity in the resultant toner particles was good. It is considered that this is because the toner mother particles had a homogeneous subglobular and were encapsulated, thereby homogenizing the surface material. In addition, since the external additives were taken in separately, the respective components thereof were homogeneously attached to the surfaces of the toner mother particles, thereby homogenizing the electrification distribution on the surfaces of the toner particles. Since silica having a large particle diameter served as a spacer and styrene-acryl resin could be more easily electrified than the polyester resin, the electrification ability using the friction with the carriers was sufficient without the function of the charge controlling agent (CCA), it is considered that the toner particles have characteristics of the electrification distribution being more easily homogenized.

### Estimation of Transfer Efficiency and Electrification Quantity

The resultant toner particles were mixed with the carriers obtained by coating the spherical ferrite particles having a volume average diameter of 40 μm with silicone resin at a toner particle ratio of 6 wt %, the mixture was provided to an electrophotographic process, and then the variations in transfer efficiency and electrification quantity with the lapse of time were estimated with the acceleration.

When the volume resistance of the intermediate transfer belt in the printer is 10⁹ Ωcm and the initial environmental condition is the normal temperature and normal humidity environment, the transfer efficiency with the toner electrification quantity of −48 μC/g and the optimal transfer bias voltage of 600 V was 99%, which was excellent.

As in Example 1, when the printing operation was performed on 60K pcs at a printing rate of 6% and the printer was left in an environment of a temperature of 32° C. and humidity of 80%, the toner electrification quantity was changed to −40 μC/g, but the transfer efficiency was 98%.

This is considered to be because the necessary transfer electric field hardly varies even with the variation in toner electrification quantity from −48 μC/g to −40 μC/g. Since the transfer efficiency is not deteriorated with the lapse of time and the variation in environment, the image quality could be maintained almost in the initial excellent state.

### COMPARATIVE EXAMPLE 1

### Preparation of Toner Particle

The toner particles were formed as follows.

First, 28 wt % of polyester resin as a resin, 7 wt % of carmine 6B as a coloring agent, and 5 wt % of rice wax as a release agent were kneaded by Kneadex made by YPK to prepare a masterbatch. The masterbatch was roughly ground, 59 wt % of polyester resin and 1 wt % of CCA (TN105) were added thereto, and then the mixture was kneaded. Toner mother particles having a volume average particle size of 6.0 μm were formed by roughly grinding and then finely grinding the resultant structure and then cutting out particles having a particle size of 8 μm or more and 4 μm or less by an elbow jet classification.

Next, based on 100 wt % of the encapsulated particles, 1.5 wt % of silica (R974: made by Japan Aerosil CO., LTD.) having a particle size of 12 nm, 1.5 wt % of silica (X-24: made by Shin-Etsu Chemical CO., LTD.) having an average particle size of 100 nm, and 0.3 wt % of titanium oxide (NKT90: made by Titan Kogyo CO., LTD.) were attached to the surfaces thereof by the use of Henschel mixer, thereby forming the toner particles. The circularity thereof was 0.94.

As in Example 1, the resultant toner particles were mixed with carriers in which spherical ferrite particles having a volume average diameter of 40 μm are coated with a silicone resin, thereby preparing the 2-component developer. The average adhesive force F (N) of the toner particles to the transport medium (photoconductive member with a dielectric constant of ε′=3. 3) was measured every unit electrification quantity while changing the electrification quantity of the toner particles by changing the mixture ratio.

As in Example 1, by plotting the average adhesive force F on the vertical axis, plotting q² on the horizontal axis, and then linearly approximating the resultant plot, F₀=6.5×10⁻⁸ (N) and K=2.20×10²¹ (N/C²) were calculated. As in Example 1, a/r of the resultant toner particles was 0.73 on the basis of the value of K when r=6.0 μm/2=3.0 μm.

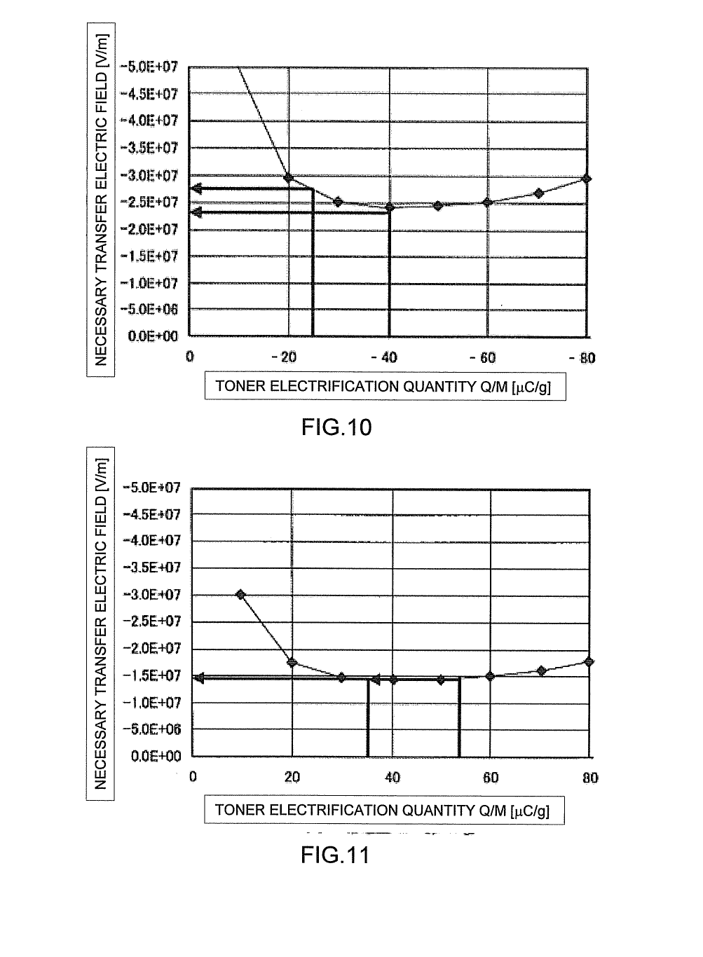

The dependency of the necessary transfer electric field E on the electrification quantity in the resultant toner particles is shown in FIG. 10. As shown in the figure, it can be seen that the variation in necessary transfer electric field E is great in the range of −20 to 80 μC/g.

This is considered to be because the rounding process was not performed and thus it was not possible to obtain the sufficient homogeneity of the electrification distribution.

### Estimation of Transfer Efficiency and Electrification Quantity

The resultant toner particles were mixed with the carriers obtained by coating the spherical ferrite particles having a volume average diameter of 40 μm with silicone resin at a toner particle ratio of 7 wt %, the mixture was provided to an electrophotographic process, and then the variations in transfer efficiency and electrification quantity with the lapse of time were estimated with the acceleration.

When the volume resistance of the intermediate transfer belt in the printer is 10⁹ Ωcm and the initial environmental condition is the normal temperature and normal humidity environment, the transfer efficiency with the toner electrification quantity of −40 μC/g and the optimal transfer bias voltage of 1,200 V was 96%, which was slightly excellent.

As in Example 1, when the printing operation was performed on 60K pcs at a printing rate of 6% and the printer was left in an environment of a temperature of 32° C. and humidity of 80%, the toner electrification quantity was changed to −25 μC/g. Accordingly, with the transfer bias voltage of 1,200 V which is equal to the initial transfer bias, the transfer efficiency was lowered to 88%.

This is considered to be because the necessary transfer electric field greatly varies with the variation in toner electrification quantity from −40 μC/g to −25 μC/g as shown in FIG. 10. Since the transfer residual toner increases, the image density was deteriorated and the image quality was also greatly deteriorated.

At this time, the necessary transfer bias was 1,500 V. However, at this voltage, since the electric field of the transfer area was too great, the charges were injected into the toner and the polarity of the charges was inverted, thereby deteriorating the transfer efficiency. Accordingly, the necessary transfer electric field was not set, thereby deteriorating the transfer efficiency. In addition, the toner consumption increased, thereby deteriorating the image quality.

### COMPARATIVE EXAMPLE 2

### Preparation of Toner Particle

The toner particles were formed as follows.

First, polyester-based prepolymer was dissolved in an organic solvent, 7 wt % of carbon black as a coloring agent, 2 wt % of stearic acid as a release agent, and 0.1 wt % of benzoyl peroxide as an polymerization initiator were dispersed in the solvent, the solvent was placed in an aqueous solvent and emulsified. Particulates having a particle size distribution including a resin, a coloring agent, and a release agent were formed by heating the resultant solvent while agitating the resultant solution.

Encapsulated particles (toner mother particles) having a volume average diameter of 5.2 μm were formed by adding prepolymer to the solvent, polymerizing the resultant solvent so as to coat the particulates therewith, and then removing the solvent and drying. The circularity was 0.95.

Next, based on 100 wt % of the encapsulated particles, 3.5 wt % of silica (R974: made by Japan Aerosil CO., LTD.) having an average particle size of 12 nm and 1.2 wt % of titanium oxide (NKT90: made by Titan Kogyo CO., LTD.) were attached to the surfaces thereof by the use of Henschel mixer, thereby forming the toner particles having a volume average diameter of 5.2 μm.

As in Example 1, the resultant toner particles were mixed with carriers in which spherical ferrite particles having a volume average diameter of 40 μm are coated with a silicone resin, thereby preparing the 2-component developer. The average adhesive force F (N) of the toner particles to the transport medium (photoconductive member with a dielectric constant of ε′=3.3) was measured every unit electrification quantity while changing the electrification quantity of the toner particles by changing the mixture ratio.

As in Example 1, by plotting the average adhesive force F on the vertical axis, plotting q² on the horizontal axis, and then linearly approximating the resultant plot, F₀=3.3×10⁻⁸ (N) and K=3.03×10²¹ (N/C²) were calculated. As in Example 1, a/r of the resultant toner particles was 0.72 on the basis of the value of K when r=5.2 μm/2=2.6 μm.

The dependency of the necessary transfer electric field E on the electrification quantity in the resultant toner particles is shown in FIG. 11. As shown in the figure, it can be seen that the variation in necessary transfer electric field E is great in the range of −20 to −80 μC/g.

This is considered to be because the external additives having a large particle size were not added thereto, thereby not obtaining the spacer effect of the external additives.

### Estimation of Transfer Efficiency and Electrification Quantity

The resultant toner particles were mixed with the carriers obtained by coating the spherical ferrite particles having a volume average diameter of 40 μm with silicone resin at a toner particle ratio of 7 wt %, the mixture was provided to an electrophotographic process, and then the variations in transfer efficiency and electrification quantity with the lapse of time were estimated with the acceleration.

When the volume resistance of the intermediate transfer belt in the printer is 10⁹ Ωcm and the initial environmental condition is the normal temperature and normal humidity environment, the transfer efficiency with the toner electrification quantity of −38 μC/g and the optimal transfer bias voltage of 1,000 V was 98%, which was excellent.

As in Example 1, when the printing operation was performed on 60K pcs at a printing rate of 6% and the printer was left in an environment of a temperature of 32° C. and humidity of 80%, the toner electrification quantity was changed to −23 μC/g. Accordingly, with the transfer bias voltage of 1,000 V which is equal to the initial transfer bias, the transfer efficiency was lowered to 90%.

This is considered to be because the necessary transfer electric field greatly varied with the variation in toner electrification quantity from −38 μC/g to −23 μC/g as shown in FIG. 11. Since the transfer residual toner increases, the image density was deteriorated and the image quality was also greatly deteriorated.

Since the necessary transfer electric field increases, a variation in transfer bias voltage is required to maintain high transfer efficiency. Accordingly, it is necessary to add a control sequence or the like therefor.

Other embodiments of the invention will be apparent to those skilled in the art from consideration of the specification and practice of the invention disclosed therein. It is intended that the specification and examples be considered as exemplary only, with a true scope and spirit of the invention being indicated by the following claims.

What is claimed is:

1. An image forming method for forming an image by transferring a toner image to a transfer medium, the toner image formed on an image bearing member by toner particles, comprising:
the toner particles including a coloring agent and a resin, and
wherein when an average electrostatic adhesive force Fₑ of the toner particles to the image bearing member is expressed by the following expression, a/r satisfies 0.2≦a/r≦0.7:
$${F}_{e} = \frac{{ɛ}^{′} - 1}{{ɛ}^{′} + 1} \cdot \frac{{q}^{2} {r}^{2}}{4 {{πɛ}_{0} ( {r}^{2} - {a}^{2} )}^{2}}$$
where ε′ is a specific dielectric constant of the image bearing member, q is an electrification quantity per one toner particle, and r is a volume average radius of the toner particles.

2. The image forming method according to claim 1, wherein the toner image is transferred to the transfer medium through a transport medium.

3. The image forming method according to claim 1, wherein the before-transfer electrification quantity Q of the toner particles satisfies −80≦Q≦−20 μC/g.

4. The image forming method according to claim 1, wherein the volume average radius r of the toner particles satisfies 1.5≦r≦4 μm.

5. The image forming method according to claim 1, wherein the non-electrostatic adhesive force F₀ of the toner particles satisfies 1.5×10⁻⁸≦F₀≦1.0×10⁻⁷ N.

6. The image forming method according to claim 1, wherein the toner particles remaining on the image bearing member are collected electrostatically.

7. An image forming method for forming an image by transferring a toner image to a transfer medium via a transport medium, the toner image formed on an image bearing member by toner particles, comprising:
the toner particles including a coloring agent and a resin, and
wherein when an average electrostatic adhesive force Fₑ of the toner particles to the transport medium is expressed by the following expression, a/r satisfies 0.2≦a/r≦0.7:
$${F}_{e} = \frac{{ɛ}^{′} - 1}{{ɛ}^{′} + 1} \cdot \frac{{q}^{2} {r}^{2}}{4 {{πɛ}_{0} ( {r}^{2} - {a}^{2} )}^{2}}$$
where ε′ is a specific dielectric constant of the transport medium, q is an electrification quantity per one toner particle, and r is a volume average radius of the toner particles.

8. The image forming method according to claim 7, wherein the before-transfer electrification quantity Q of the toner particles satisfies −80≦Q≦−20 μC/g.

9. The image forming method according to claim 7, wherein the volume average radius r of the toner particles satisfies 1.5≦r≦4 μm.

10. The image forming method according to claim 7, wherein the non-electrostatic adhesive force F₀ of the toner particles satisfies 1.5×10⁻⁸≦F₀≦1.0×10⁻⁷ N.

11. The image forming method according to claim 7, wherein the toner particles remaining on the transport medium are collected electrostatically.

12. A developer having toner particles, for forming an image by transferring a toner image to a transfer medium, the toner image formed on an image bearing member by the toner particles, comprising:
the toner particles including a coloring agent and a resin, and
wherein when an average electrostatic adhesive force Fₑ of the toner particles to the image bearing member is expressed by the following expression, a/r satisfies 0.2≦a/r≦0.7:
$${F}_{e} = \frac{{ɛ}^{′} - 1}{{ɛ}^{′} + 1} \cdot \frac{{q}^{2} {r}^{2}}{4 {{πɛ}_{0} ( {r}^{2} - {a}^{2} )}^{2}}$$
where ε′ is a specific dielectric constant of the image bearing member, q is an electrification quantity per one toner particle, and r is a volume average radius of the toner particles.

13. The developer according to claim 12, wherein the before-transfer electrification quantity Q of the toner particles satisfies −80≦Q≦−20 μC/g.

14. The developer according to claim 12, wherein the volume average radius r of the toner particles satisfies 1.5≦r≦4 μm.

15. The developer according to claim 12, wherein the non-electrostatic adhesive force F₀ of the toner particles satisfies 1.5×10⁻⁸≦F₀≦1.0×10⁻⁷ N.

16. A developer having toner particles, for forming a toner image formed by the toner particles on a transfer medium through a transport medium, comprising:
the toner particles including a coloring agent and a resin, and
wherein when an average electrostatic adhesive force Fₑ of the toner particles to the transport medium is expressed by the following expression, a/r satisfies 0.2≦a/r≦0.7:
$${F}_{e} = \frac{{ɛ}^{′} - 1}{{ɛ}^{′} + 1} \cdot \frac{{q}^{2} {r}^{2}}{4 {{πɛ}_{0} ( {r}^{2} - {a}^{2} )}^{2}}$$
where ε′ is a specific dielectric constant of the transport medium, q is an electrification quantity per one particle of the toner, and r is a volume average radius of the toner particles.

17. The developer according to claim 16, wherein the before-transfer electrification quantity Q of the toner particles satisfies −80≦Q≦−20 μC/g.

18. The developer according to claim 16, wherein the volume average radius r of the toner particles satisfies 1.5≦r≦4 μm.

19. The developer according to claim 16, wherein the non-electrostatic adhesive force F₀ of the toner particles satisfies 1.5×10⁻⁸≦F₀≦1.0×10⁷ N.
